(19) United States
(12) Patent Application Publication
(10) Pub. No.: US 2024/0169060 A1
(43) Pub. Date: May 23, 2024

(54) METHOD AND SYSTEM FOR VERIFYING QUICK RESPONSE CODES

(71) Applicant: International Business Machines Corporation, Armonk, NY (US)

(72) Inventors: Nicholas C. Proff, New Braunfels Comal, TX (US); Leslie Rodriguez, Doral, FL (US)

(21) Appl. No.: 18/056,941

(22) Filed: Nov. 18, 2022

(51) Int. Cl. G06F 21/55; G06F 21/36; G06F 21/54

(52) U.S. Cl. CPC G06F 21/554; G06F 21/36; G06F 21/54

(57) ABSTRACT

A computer-implemented method (CIM) that includes receiving an image including a QR code and an area surrounding the QR code, visually inspecting the image of the QR code and the surrounding area, determining whether the QR code and the surrounding area include at least one indication of tampering, and alerting a user of the mobile device to physically check the QR code, if at least one indication of tampering is determined.

### BACKGROUND

The present disclosure relates generally to security, and more specifically, to a method and system for verifying quick response (QR) codes.

QR codes have become an integral part of today's society. They provide easy access to certain websites through a user's mobile device and provide touch-free options due to health concerns.

### SUMMARY

According to some embodiments of the disclosure, there is provided a computer-implemented method (CIM). The CIM includes receiving an image including a QR code and an area surrounding the QR code, visually inspecting the image of the QR code and the surrounding area, determining whether the QR code and the surrounding area include at least one indication of tampering, and alerting a user of the mobile device to physically check the QR code, if at least one indication of tampering is determined.

According to some embodiments of the disclosure, there is provided a system including a memory, and a processor communicatively coupled to the memory, wherein the processor is configured to perform a method. The method includes operations to: receive an image including a QR code and an area surrounding the QR code, visually inspect the image of the QR code and the surrounding area, determine whether the QR code and the surrounding area include at least one indication of tampering, and alert a user of the mobile device to physically check the QR code, if at least one indication of tampering is determined.

According to some embodiments of the disclosure, there is provided a computer program product comprising a computer readable storage medium having a computer readable program stored therein, wherein the computer readable program, when executed by a processor, causes the processor to perform a method. The method includes operations to: receive an image including a QR code and an area surrounding the QR code, visually inspect the image of the QR code and the surrounding area, determine whether the QR code and the surrounding area include at least one indication of tampering, and alert a user of the mobile device to physically check the QR code, if at least one indication of tampering is determined.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram view of a system, in accordance with some embodiments.

FIG. 2 is a block diagram showing a visual inspection module (for example, software) portion of the system of FIG. 1, in accordance with some embodiments.

FIG. 3 is a flowchart showing a method, in accordance with some embodiments.

FIG. 4 is a flowchart showing a method, in accordance with some embodiments.

FIG. 5 is a flowchart showing a method, in accordance with some embodiments.

FIG. 6 is a flowchart showing a method, in accordance with some embodiments.

FIG. 7 is a flowchart showing a method, in accordance with some embodiments.

FIG. 8 is a flowchart showing a method, in accordance with some embodiments.

FIG. 9 is a QR code in a surrounding area (or a background), in accordance with some embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to security, and more specifically, to a method and system for verifying the authenticity, validity or legitimacy of quick response (QR) codes.

A QR code is a type of two-dimensional bar code that consists of square black modules on a white background. QR codes are designed to be read by smartphones, mobile devices and other similar devices. Because they can carry information both vertically and horizontally, the QR codes can provide access to a vast amount of information, including links, text or other data.

A problem has risen from the use of QR codes, which is that QR codes have been used for malicious purposes. For example, bad actors have placed malicious QR codes on top of other safe QR codes without a user being aware of any tampering or manipulation. A “safe” QR code is one that can be verified, authenticated, validated and/or legitimized, and was not tampered with or manipulated for malicious purposes. Scanning unsafe, or malicious, QR codes can expose the user's device and the user's information to the bad actors. When the user opens an unsafe QR code on a device, personal information can be gathered without the user's knowledge, and/or links can be included, that look like legitimate websites.

Disclosed are methods and systems for verifying QR codes that aim to use visual inspection before a user scans a QR code. In order to scan the QR code, the user needs to open their camera application on their mobile device. The camera application can detect when it sees a QR code in an image. When the QR code is detected, the camera application can automatically execute a visual inspection on areas surrounding (or background) of the QR code before it makes the QR code active and the user's device is forwarded to a website, for example. During the visual inspection, if a computer program deems that the QR code does not have any visual indications of tampering, then the program can allow the user to continue to view the website link, for example. If the computer program deems that the QR code does have some visual indications of tampering, then the program can provide the user with a notification to let the user know of possible tampering and request that the user physically check the QR code or use an alternative method to navigate to the link. The user can then choose to navigate to the link or they can choose to not navigate to the link, which allows the user to make an informed decision.

In some embodiments, during the visual inspection of the QR code and surrounding area, a series of operations can be used to set up or prepare for verification of the QR code. In an operation, data can be collected from multiple sources that show good and bad examples of QR codes that are placed across different surfaces and on other locations or backgrounds. Another operation is that the data can be labeled to prepare for consumption in a machine learning model that can understand how to find a proper QR code, versus a QR code that may show signs of tampering to alert the user to a security threat. Some examples of indications of tampering with the QR code include, for example: wear-and-tear on a QR code sticker; shadows in the QR code sticker, which could point to another sticker being underneath; identification of other shapes around the QR code sticker that could point to the QR code sticker covering something else underneath; the QR code sticker not being flat; the QR code sticker having folded corners or creases; the QR code sticker having a very distinct color from a surrounding surface, possibly indicating that the QR code sticker may have been placed at a different time or by a different person; and misspellings on the QR code sticker. In another operation, with the data collected and labeled, the machine learning model can be built for object detection, classification, and segmentation. Yet another operation, after the machine learning model has been trained and validated, can include deployment to the user's mobile device. During a QR code scan, after the operations discussed above, the camera application can identify where the QR code is, label it and provide a bounding box and understand the area surrounding the QR code. The camera application can receive a score to indicate the machine learning model's confidence level on the QR code and whether or not to alert the user to a security threat. The confidence level is the amount of confidence that the QR code is safe or verified. Yet another operation includes re-training the machine learning model as more data is collected.

In some embodiments, when a QR code is detected by a camera on a mobile device, a camera application on the mobile device can execute a visual inspection with a computer learning algorithm using known image edge detection and contrast sensitivities of surrounding areas and the QR code. Such a process of visual inspection of a QR code can include an operation of labelling data to ensure that the data are ready for consumption in a machine learning model. The machine learning model can determine how to identify a proper QR code from a QR code that shows signs or indications that can alert a user to a security threat. Some examples of indications of tampering with the QR code include, for example: wear-and-tear on a QR code sticker; shadows in the QR code sticker, which could point to another sticker being underneath; identification of other shapes around the QR code sticker that could point to the QR code sticker covering something else underneath; the QR code sticker not being flat; the QR code sticker having folded corners or creases; the QR code sticker having a very distinct color from a surrounding surface, possibly indicating that the QR code sticker may have been placed at a different time or by a different person; and misspellings on the QR code sticker. An image of a QR can be loaded into the camera application and converted to grayscale.

“Grayscale” is a collection or a range of monochromic (gray) shades, ranging from pure white on a lightest end to pure black on an opposite end. Grayscale only contains luminance (brightness) information and no color information; that is why maximum luminance is white and zero luminance is black; everything in between is a shade of gray. That is why grayscale images contain only shades of gray and no color.

“Contrast” is defined as a difference in light intensity between an image and adjacent background relative to an overall intensity of the background (or surrounding area). “Contrast sensitivity” is a measure of the ability of a visual system to distinguish an object against its background (or surrounding area).

Edges (i.e., outside limits of an object) of the QR code can be detected using algorithms in OpenCV (open source computer vision library), such as Canny, Sobel, etc. The “CV” in OpenCV is an abbreviation form of a computer vision, which is defined as a field of study that helps computers to understand the content of digital images, such as photographs and videos. The OpenCV can help to point out where the QR code, and other objects surrounding the QR code, are located. From edge detection, if there are any objects that can be located behind the QR code, the QR code could be indicated as untrustworthy or unofficial. In such a case, a user can be alerted to double-check the QR code physically.

Additionally, or alternatively, contrast levels between the QR code and objects in the background and surrounding areas can be compared. Packages in OpenCV can be used to contrast and compare the QR code with general background contrast levels. If contrast levels between the QR code and the background vary greatly, then it can indicate that the QR code is “new” and may be a scam. The user can be alerted to double-check the QR code.

Objects in an image pool can be pre-loaded into the machine learning model. The objects can be example of good (or safe) QR codes and bad (or unsafe) QR codes that indicate tampering or malicious intent. If an object is matched to a bad example, then the user can be alerted to double-check the QR code physically.

Text appearing in any picture or surrounding area of the QR code can be checked for misspellings using an OpenCV text detection package, for example. If misspellings are found, an alert can be provided to a user that the QR code could possibly be a scam.

During a QR code scan, the camera application can identify where the QR code is, label the QR code, provide a bounding box (a rectangle that surrounds an object), and understand surrounding areas of the QR code. The camera application can receive a score to indicate the machine learning model's confidence level on the QR code and whether to alert the user. The machine learning model can be retrained as more data can be collected.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the disclosed methods, such as QR code visual inspection module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

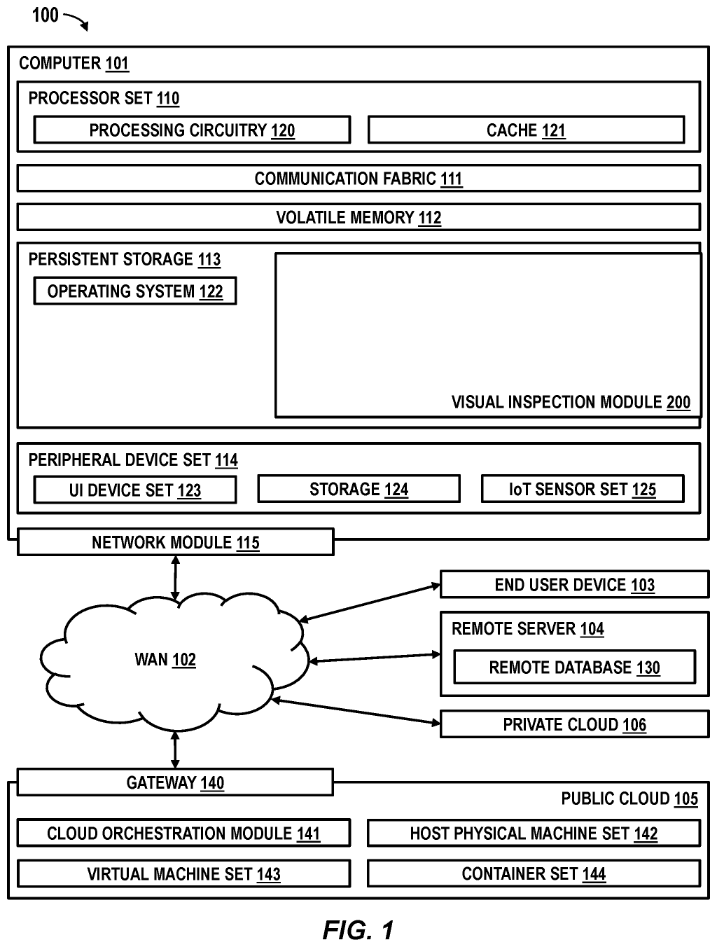

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 121 and the other storage media discussed below. The program instructions, and associated data, are accessed by processor set 110 to control and direct performance of the disclosed methods. In computing environment 100, at least some of the instructions for performing the disclosed methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the disclosed methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the disclosed methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

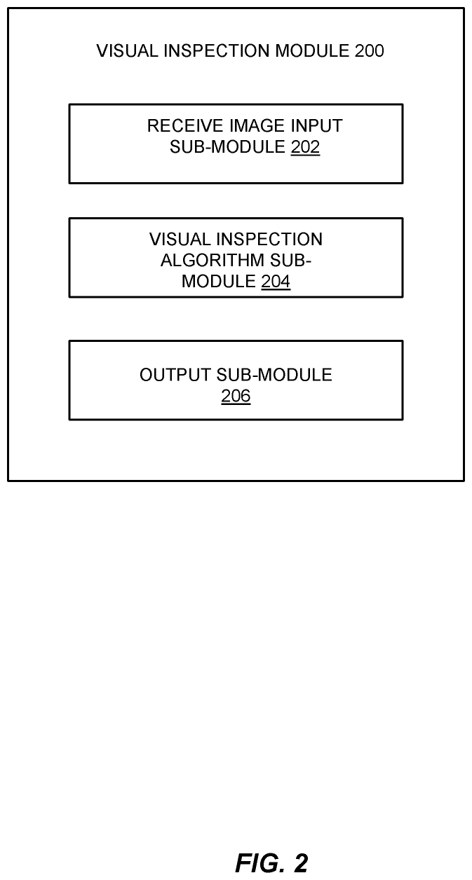

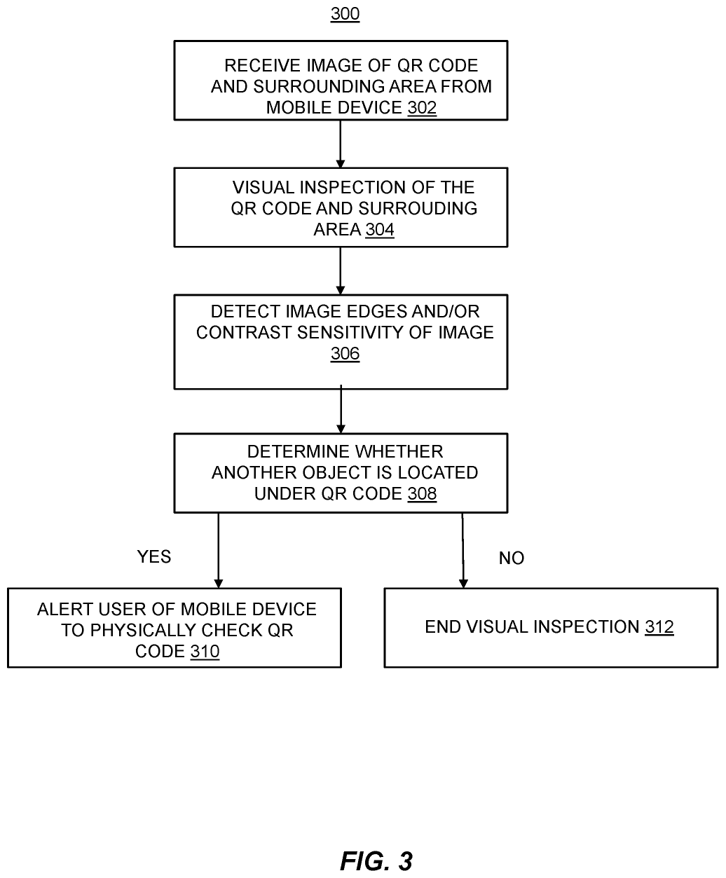

Computing environment 100 is an environment in which an example method according to the present disclosure can be performed. As shown in FIGS. 3-8, flowcharts 300-800 show example methods according to the present disclosure. As shown in FIG. 2, visual inspection module 200 performs or controls performance of at least some of the method operations of flowcharts 300-800. FIG. 2 shows the visual inspection module 200 can include a receive image input sub-module 202, a visual inspection algorithm sub-module 204, and an output sub-module 206, for example. The methods and associated software will now be discussed, over the course of the following paragraphs.

FIG. 3 is a flowchart showing a process 300, in accordance with some embodiments. An operation 302 of the process 300 is to receive an image of a QR code and a surrounding area from a mobile device (i.e., end user device 103, in FIG. 1). Another operation 304 is visual inspection of the QR code and surrounding area using the visual inspection module 200 (FIG. 2), for example, which uses a visual inspection algorithm (as in submodule 204). The visual inspection module 200 (FIG. 2) can perform another operation 306 of detecting image edges and/or contrast sensitivity of the surrounding area. Another operation 308 is to determine whether another object is located under the QR code. If another object is detected, another operation 310 is to provide an alert to a user of the mobile device to physically check the QR code. If another object is not detected under the QR code, an alternative operation 312 is to end the visual inspection.

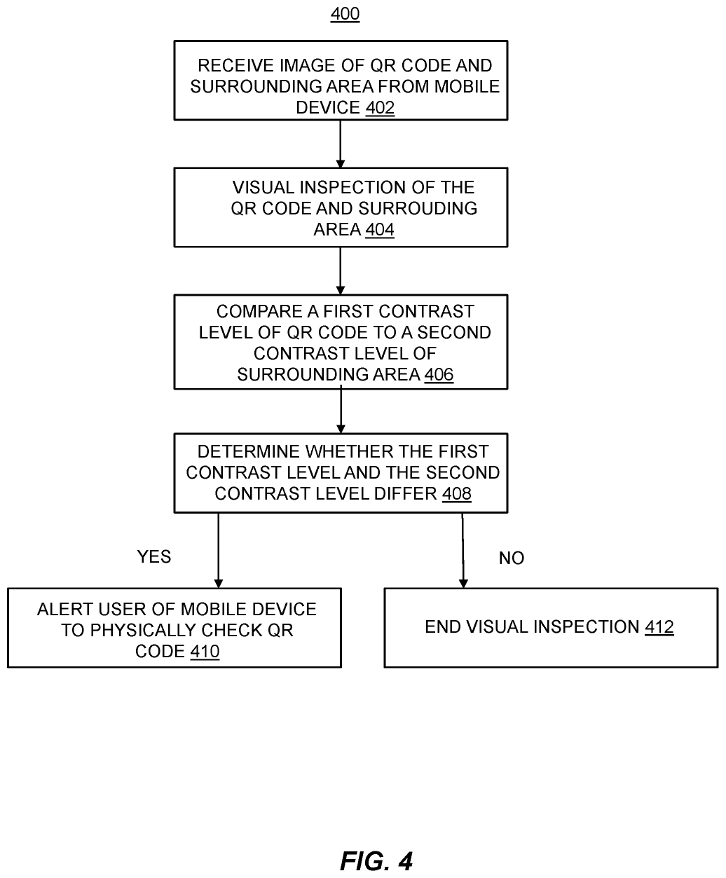

FIG. 4 is a flowchart showing a process 400, in accordance with some embodiments. An operation 402 of the process 400 is to receive an image of a QR code and a surrounding area from a mobile device (i.e., end user device 103, in FIG. 1). Another operation 404 is visual inspection of the QR code and surrounding area using the visual inspection module 200 (FIG. 2), for example, which uses a visual inspection algorithm (as in submodule 204). The visual inspection module 200 (FIG. 2) can perform another operation 406 of comparing a first contrast level of the QR code to a second contrast level of the surrounding area. Another operation 408 is to determine whether the first contrast level and the second contrast level differ, and possibly different to a significant degree. If so, another operation 410 is to provide an alert to a user of the mobile device to physically check the QR code. If not, an alternative operation 412 is to end the visual inspection.

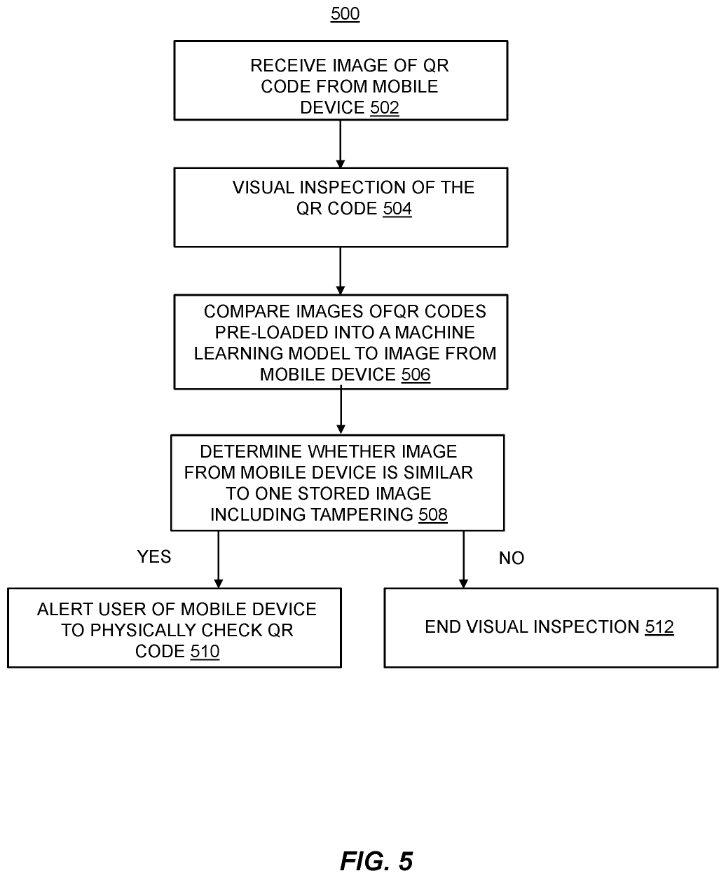

FIG. 5 is a flowchart showing a process 500, in accordance with some embodiments. An operation 502 of the process 500 is to receive an image of a QR code from a mobile device (i.e., end user device 103, in FIG. 1). Another operation 504 is visual inspection of the QR code using the visual inspection module 200 (FIG. 2), for example, which uses a visual inspection algorithm (as in submodule 204). The visual inspection module 200 (FIG. 2) can perform another operation 506 of comparing images of QR codes that have been pre-loaded into a machine learning model to the image from the mobile device. Another operation 508 is to determine whether the image from the mobile device is similar to at least one pre-loaded image that includes tampering or was deemed malicious in some way. If so, another operation 510 is to provide an alert to a user of the mobile device to physically check the QR code. If not, an alternative operation 512 is to end the visual inspection.

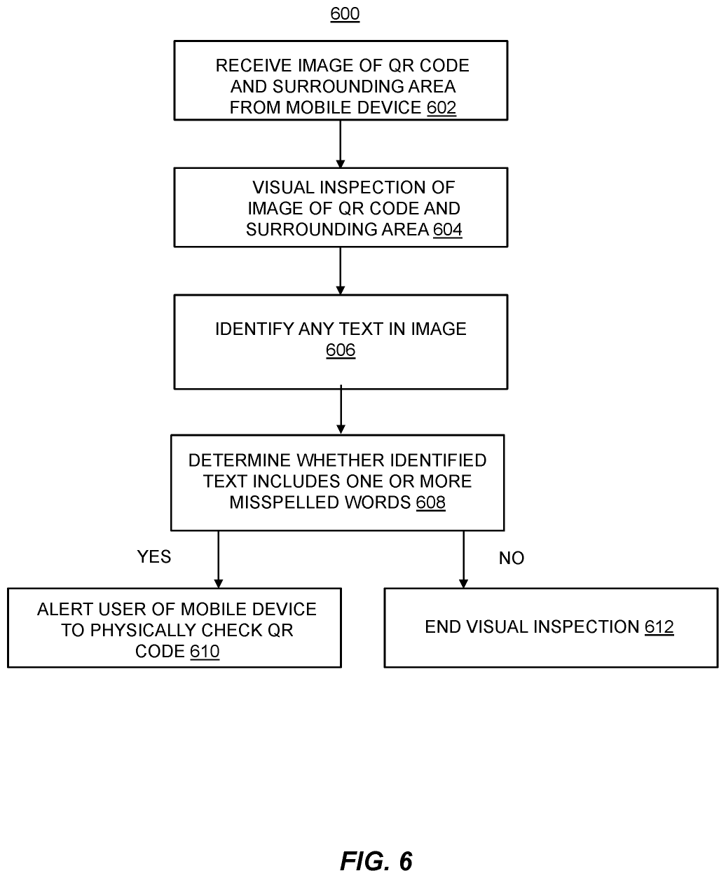

FIG. 6 is a flowchart showing a process 600, in accordance with some embodiments. An operation 602 of the process 600 is to receive an image of a QR code and a surrounding area from a mobile device (i.e., end user device 103, in FIG. 1). Another operation 604 is visual inspection of the QR code and surrounding area using the visual inspection module 200 (FIG. 2), for example, which uses a visual inspection algorithm (as in submodule 204). The visual inspection module 200 (FIG. 2) can perform another operation 606 of identifying any text in the QR code and/or surrounding area. Another operation 608 is to determine whether identified text includes one or more misspelled words. If so, another operation 610 is to provide an alert to a user of the mobile device to physically check the QR code. If not, an alternative operation 612 is to end the visual inspection.

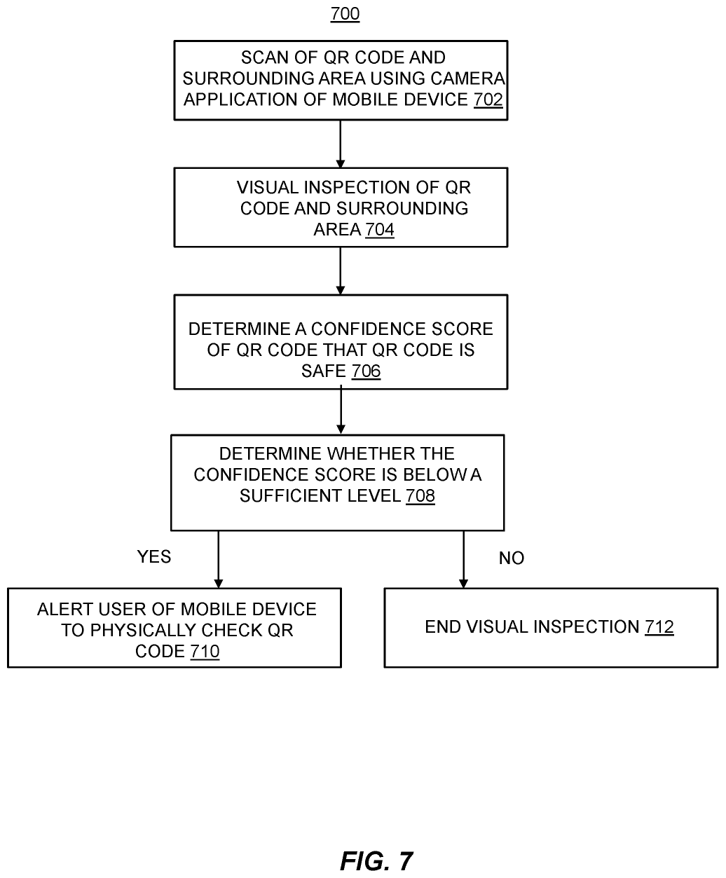

FIG. 7 is a flowchart showing a process 700, in accordance with some embodiments. An operation 702 of the process 700 is to scan a QR code and a surrounding area using a camera application of a mobile device (i.e., end user device 103, in FIG. 1). Another operation 704 is visual inspection of the QR code and surrounding area using the visual inspection module 200 (FIG. 2), for example, which uses a visual inspection algorithm (as in submodule 204). The visual inspection module 200 (FIG. 2) can perform another operation 706 of determining a confidence score of the QR code that the QR code is safe. Another operation 708 is to determine whether the confidence score is below a sufficient level. If the confidence score is below a certain (sufficient) level, then it can indicate that the QR code is unsafe. If so, another operation 710 is to provide an alert to a user of the mobile device to physically check the QR code. If not, an alternative operation 712 is to end the visual inspection.

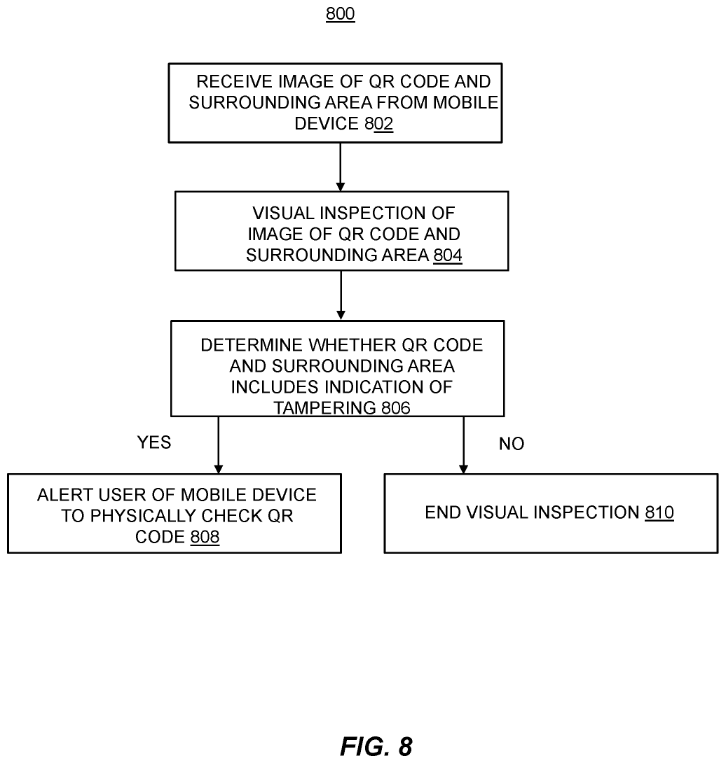

FIG. 8 is a flowchart showing a process 800, in accordance with some embodiments. An operation 802 of the process 800 is to scan a QR code and a surrounding area using a camera application, for example, of a mobile device (i.e., end user device 103, in FIG. 1). Another operation 804 is visual inspection of the QR code and surrounding area using the visual inspection module 200 (FIG. 2), for example, which uses a visual inspection algorithm (as in submodule 204). The visual inspection module 200 (FIG. 2) can perform another operation 806 of determining whether the QR code includes any indication of tampering. If so, another operation 808 is to provide an alert to a user of the mobile device to physically check the QR code. If not, an alternative operation 810 is to end the visual inspection.

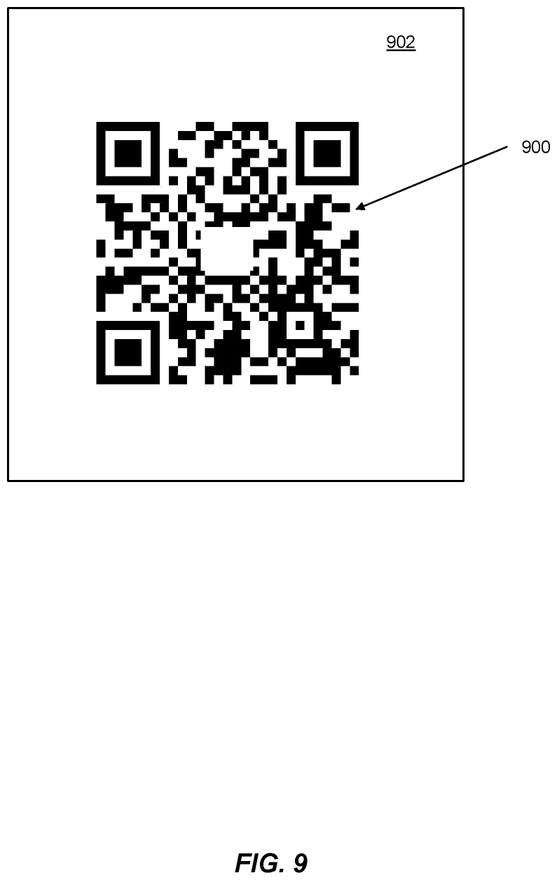

FIG. 9 shows a QR code 900 in a surrounding area (or a background) 902, in accordance with some embodiments. One example of the QR code 900 is shown and can be any appropriate design. In the disclosed processes, a camera application on a mobile device can take an image of the QR code 900 and it can cause the mobile device to do something else, such as, for example, access a website. An image can be taken of the surrounding area 902 on a surface of an object, as well as the QR code 900, in order to compare the QR code 900 to the surrounding area 902, for example, or to view any indications of tampering with the QR code 900 located on the surrounding area 902, etc.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method (CIM) comprising:
receiving an image including a QR code and an area surrounding the QR code;
visually inspecting the image of the QR code and the surrounding area;
determining whether the QR code and the surrounding area include at least one indication of tampering; and
alerting a user of the mobile device to physically check the QR code, if at least one indication of tampering is determined.

2. The CIM of claim 1, further comprising:
detecting edges of the QR code.

3. The CIM of claim 1, further comprising:
detecting contrast sensitivity of the image.

4. The CIM of claim 1, further comprising:
determining whether another object is located under the QR code, wherein another object under the QR code indicates tampering.

5. The CIM of claim 1, further comprising:
determining a first contrast level of the QR code and a second contrast level of the surrounding area; and
determining whether the first contrast level and the second contrast level differ, wherein a difference indicates tampering.

6. The CIM of claim 1, further comprising:
comparing the received image of the QR code to a plurality of images of QR codes that both include and do not include indications of tampering, wherein the plurality of images of QR codes were stored in a computer; and
determining whether the received image of the QR code is similar to at least one of the plurality of images of QR codes stored in the computer.

7. The CIM of claim 1, further comprising:
determining a confidence score of the QR code that the QR code is safe; and
determining whether the confidence score is below a sufficient level, wherein the confidence score being below the sufficient level indicates tampering.

8. The CIM of claim 1, further comprising:
identifying any text in the image; and
determining whether the identified text includes one or more misspelled words, wherein the presence of misspelled words indicates tampering.

9. A system comprising:
a memory; and
a processor communicatively coupled to the memory, wherein the processor is configured to perform a method comprising:
receive an image including a QR code and an area surrounding the QR code;
visually inspect the image of the QR code and the surrounding area;
determine whether the QR code and the surrounding area include at least one indication of tampering; and
alert a user of the mobile device to physically check the QR code, if at least one indication of tampering is determined.

10. The system of claim 9, wherein the processor is further configured to perform the method further comprising:
determine whether another object is located under the QR code, wherein another object under the QR code indicates tampering.

11. The system of claim 9, wherein the processor is further configured to perform the method further comprising:
determine a first contrast level of the QR code and a second contrast level of the surrounding area; and
determine whether the first contrast level and the second contrast level differ, wherein a difference indicates tampering.

12. The system of claim 9, wherein the processor is further configured to perform the method further comprising:
compare the received image of the QR code to a plurality of images of QR codes that both include and do not include indications of tampering, wherein the plurality of images of QR codes were stored in a computer; and
determine whether the received image of the QR code is similar to at least one of the plurality of images of QR codes stored in the computer.

13. The system of claim 9, wherein the processor is further configured to perform the method further comprising:
determine a confidence score of the QR code that the QR code is safe; and
determine whether the confidence score is below a sufficient level, wherein the confidence score being below the sufficient level indicates tampering.

14. The system of claim 9, wherein the processor is further configured to perform the method further comprising:
identify any text in the image; and
determine whether the identified text includes one or more misspelled words, wherein the presence of misspelled words indicates tampering.

15. A computer program product comprising a computer readable storage medium having a computer readable program stored therein, wherein the computer readable program, when executed by a processor, causes the processor to perform a method comprising:
receive an image including a QR code and an area surrounding the QR code;
visually inspect the image of the QR code and the surrounding area;
determine whether the QR code and the surrounding area include at least one indication of tampering; and
alert a user of the mobile device to physically check the QR code, if at least one indication of tampering is determined.

16. The computer program product of claim 15, wherein the program instructions cause the processor to:
determine whether another object is located under the QR code, wherein another object under the QR code indicates tampering.

17. The computer program product of claim 15, wherein the program instructions cause the processor to:
determine a first contrast level of the QR code and a second contrast level of the surrounding area; and
determine whether the first contrast level and the second contrast level differ, wherein a difference indicates tampering.

18. The computer program product of claim 15, wherein the program instructions cause the processor to:
compare the received image of the QR code to a plurality of images of QR codes that both include and do not include indications of tampering, wherein the plurality of images of QR codes were stored in a computer; and
determine whether the received image of the QR code is similar to at least one of the plurality of images of QR codes stored in the computer.

19. The computer program product of claim 15, wherein the program instructions cause the processor to:
determine a confidence score of the QR code that the QR code is safe; and
determine whether the confidence score is below a sufficient level, wherein the confidence score being below the sufficient level indicates tampering.

20. The computer program product of claim 15, wherein the program instructions cause the processor to:
identify any text in the image; and
determine whether the identified text includes one or more misspelled words, wherein the presence of misspelled words indicates tampering.
